(19) United States
(12) Patent Application Publication
(10) Pub. No.: US 2023/0342832 A1
(43) Pub. Date: Oct. 26, 2023

(54) POPULATION OF DYNAMIC VEHICLE CONTENT IN ELECTRONIC COMMUNICATIONS

(71) Applicant: Tekion Corp, Pleasanton, CA (US)

(72) Inventors: Abhinandan Sahgal, Bengaluru (IN); Gaurav Gupta, Chandigarh (IN); Saikumaar Nagarajan, Bangalore (IN); Nitika Gupta, Bengaluru (IN)

(21) Appl. No.: 17/729,919

(22) Filed: Apr. 26, 2022

(51) Int. Cl. G06Q 30/06; G06N 20/00; G06K 9/62

(52) U.S. Cl. CPC G06Q 30/0631; G06N 20/00; G06K 9/6256

(57) ABSTRACT

Embodiments relate to a system for automatically populating fields of an electronic communication with content items, and providing recommendations relating to one or more vehicles to a selected entity. Responsive to receiving a request associated with drafting an electronic communication to a specified entity, the system generates an input vector using metadata associated with the entity comprising at least a context of a current interaction with the entity, and historical data associated with the entity generated based upon one or more previous interactions of the entity relating to one or more vehicles. A trained machine learning model uses the input vector to generate content item recommendations pertaining to a selected vehicle corresponding to the fields of a selected template. Recommended content items are used to populate the fields of the selected template to generate the electronic communication.

### TECHNICAL FIELD

The disclosure generally relates to the field of machine learning, and more particularly relates to dynamic content generation using neural networks.

### BACKGROUND

A dealer management system (DMS) stores information relating to a plurality of different vehicles and a plurality of different entities associated with vehicle dealerships. A user of the DMS may draft electronic communication to entities populated with various content items. In a conventional system, the user may manually select and place content items to be included in the communication, based upon their knowledge of the entity and their subjective judgment as to which content items are most likely to result in a desired response from the entity. However, such methods are time-consuming and yield inconsistent results. In addition, existing machine learning solutions are often unintuitive for users to use, and due to the multitude of content items and way in which content items may be arranged in an electronic communication, are not able to draft an electronic communication in an efficient and consistent manner.

### SUMMARY

Systems and methods are disclosed herein for automatically populating fields of an electronic communication with content items, to provide recommendations relating to one or more vehicles to a selected entity. In some embodiments, a computer-implemented method comprises, responsive to receiving a request associated with drafting an electronic communication to a specified entity, accessing metadata associated with the entity. The metadata comprises at least a context of a current interaction with the entity, and historical data associated with the entity, where the historical data generated based upon one or more previous interactions of the entity relating to one or more vehicles. The method further comprises generating an input vector based upon the accessed metadata comprising the context and at least a portion of the historical data, wherein the at least a portion of the historical data is selected from the historical data based upon the context, and applying the generated input vector to a trained machine learning model to generate an output vector indicating a plurality of content item recommendations pertaining to a selected vehicle of the one or more vehicles, wherein types of content item recommendations indicated in the output vector are based on the context of the interaction, and wherein at least one content item recommendation of the plurality of content item recommendations corresponds to a multimedia content item of the selected vehicle. The method further comprises receiving an input indicating acceptance of at least a portion of the plurality of content item recommendations indicated by the generated output vector, retrieving content items corresponding to the accepted content item recommendations, and automatically populating one or more fields of the electronic communication using the retrieved content items.

In accordance with some embodiments, training data to train the machine learning model is generated by accessing historical data corresponding to a plurality of different entities, generated based upon previous interactions of the plurality of entities relating to one or more vehicles, accessing content information of electronic communications sent to entities of the plurality of entities, indicating content items used to populate one or more fields in each of the electronic communications, accessing results information indicating subsequent actions of entities of the plurality of entities responsive to receiving electronic communications, and correlating the results information with the access content information and historical data associated with the plurality of different entities to generate the training data. The machine learning model may then be trained using the generated training data.

In accordance with some embodiments, the computer-implemented method further comprises receiving information indicating a subsequent action of the entity responsive to receipt of the electronic communication, updating the training data based on the subsequent action, and retraining the trained machine learning model based upon the updated training data.

In accordance with some embodiments, the historical data associated with the entity indicates an affinity between the entity and at least one aspect of the one or more vehicles. The at least one aspect of the one or more vehicles may correspond to a type of the one or vehicles, a physical aspect of the one or more vehicles, or a feature set of the one or more vehicles. In some embodiments, the multimedia content item is selected based at least in part upon the indicated affinity.

In accordance with some embodiments, the historical data is generated using a tracking pixel configured to track interactions between the entity and one or more third-party websites, and indicates one or more affinities of the entity determined based upon interaction of the entity with the one or more third-party web site.

In accordance with some embodiments, the electronic communication is associated with a template specifying the one or more fields of the electronic communication to be populated with content items. In some embodiments, the input vector to the trained machine learning model comprises an indication of the template, and the trained machine learning model generates the output vector indicating the plurality of content item recommendations based upon content item types associated with the one or more fields specified by the template. In some embodiments, the template is selected based upon the context of the current interaction with the entity. In some embodiments, the output vector generated by the trained machine learning model indicates an arrangement of one or more templates, and wherein the plurality of content items recommendations indicted by the output vector are selected based upon fields specified by the one or more templates.

In some embodiments, the multimedia content item corresponds to a picture or a video depicting an aspect of the selected vehicle.

In accordance with some embodiments, the context indicates whether a type of the current interaction with the entity relates to a vehicle of the one or more vehicles or a service contract for a vehicle of the one or more vehicles.

In accordance with some embodiments, the machine learning model is a neural network comprising a plurality of hidden layers, each hidden layer comprising a plurality of hidden nodes, wherein the instructions further comprise instructions to train the neural network by determining weights associated with connections between the plurality of hidden nodes to minimize a loss function.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram of a system environment in which an electronic communication augmentation system operates, in accordance with at least one embodiment.

FIG. 2 is a block diagram of the electronic communication augmentation system of FIG. 1, in accordance with at least one embodiment.

FIG. 3 shows a diagram of an example neural network maintained by an electronic communication augmentation system, in accordance with at least one embodiment.

FIGS. 4A and 4B depict a graphical user interface (GUI) for generating electronic communications, in accordance with at least one embodiment.

FIG. 5 illustrates an example of a GUI for generating electronic communications implemented as a plug-in for an email application, in accordance with at least one embodiment.

FIG. 6 is a flowchart illustrating a process for automatically populating fields of an electronic communication with content items, in accordance with at least one embodiment.

FIG. 7 is a flowchart illustrating a process for training a machine learning model, such as a neural network, in accordance with at least one embodiment.

FIG. 8 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Environment

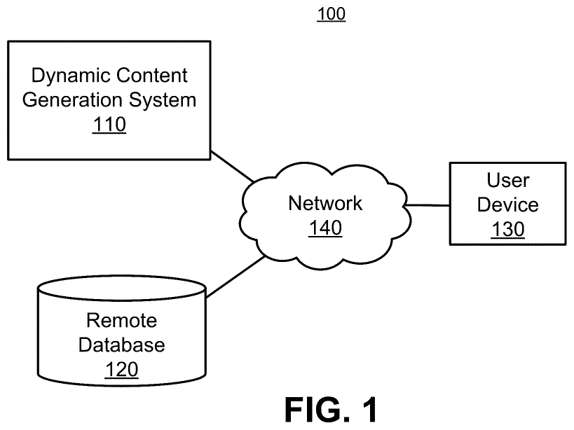

FIG. 1 is a block diagram of system environment 100 in which an electronic communication augmentation system operates, in accordance with at least one embodiment. System environment 100 includes electronic communication augmentation system 110, remote database 120, user device 130, and network 140. System environment 100 may have alternative configurations than shown in FIG. 1, including for example different, fewer, or additional components. For example, in some embodiments, the remote database may be implemented as part of the electronic communication augmentation system 110. In other embodiments, the electronic communication augmentation system 110 and/or remote database 120 may be communicatively coupled to a third party system (e.g., a third party vehicle manufacturer, not shown) through network 140. In some embodiments, the system environment 100 may be implemented as part of a DMS.

Electronic communication augmentation system 110 is configured to automatically populate and arrange vehicle content for electronic communications, based upon a current interaction state with an entity to receive the electronic communication, as well as historical metadata associated with the entity. As referred to herein, an “electronic communication” may correspond to any communication transmitted by means of an electronic device, such as an email, SMS message, etc., and may include textual data, audio data, multimedia data, etc. In some embodiments, the electronic communication augmentation system 110 automatically populates fields of an electronic communication with vehicle content items, based upon a selected template, a context of a current interaction with the entity, and historical data associated with the entity, where the historical data is generated based upon one or more previous interactions of the entity relating to one or more vehicles. As referred to herein, a vehicle content item may refer to a content item relating to a vehicle or an aspect of a vehicle (e.g., type of the one or vehicles, a physical aspect of the one or more vehicles, or a feature set of the one or more vehicles), where a “vehicle” may refer to an automobile, bicycle, scooter, aircrafts, watercrafts, or any suitable machine for transportation. The vehicle may be automated, semiautomated, or manually operated. Content items may include textual content, multimedia content (e.g., pictures, audio, video), or some combination thereof (e.g., a content item comprising a picture and a corresponding text caption). As used herein, an “entity” may refer to an individual, group, organization, or some combination thereof.

Electronic communication augmentation system 110 uses a machine learning model (e.g., a neural network) to generate vehicle content item recommendations pertaining to a selected vehicle of the one or more vehicles, wherein types of content item recommendations a context of the interaction, and historical data associated with the entity to which the electronic communication is to be transmitted. In some embodiments, at least one content item recommendation of the plurality of content item recommendations corresponds to a multimedia content item depicting one or more aspects of the selected vehicle. The machine learning model may be trained based upon historical data associated with a plurality of entities, comprising, for example, data associated with previous interactions with the entity, entity attributes such as current vehicle owned, vehicle purchase history, etc., content items of previous electronic communications with the entity, results of previous electronic communications with the entity, etc.

In some embodiments, the electronic communication augmentation system 110 is configured to utilize templates for configuring electronic communications. In some embodiments, a template specifies one or more fields corresponding to vehicle content items for which recommendations are to be generated for. Each field may correspond to a location within the electronic communication, and specify a type of vehicle content item to be used to populate the field. In some embodiments, electronic communication augmentation system 110 receives input via a user interface indicating a selection from a user of a template to be used for an electronic communication. In other embodiments, a template for an electronic communication is selected automatically based upon a context of an interaction with the entity. In some embodiments, templates may be selected from a template library, in which stored templates may be categorized based upon types of interaction and/or interaction contexts. The electronic communication augmentation system 110 generates for display a plurality of selectable options, each corresponding to a different candidate template, the candidate templates selected based upon the interaction context with the entity, and receives a selection from a user of a template corresponding to one or more of the selectable options, and responsively populates the selected template.

In some embodiments, the electronic communication may correspond to an email message to an entity. When drafting the email, a user selects a desired template to be used for the email. The template may include a plurality of placeholder fields, and is configured to, using the trained machine learning model, contextually auto-populate with vehicle content based on the entity, such as vehicle content relating to a vehicle that the entity has expressed an affinity for, which may be retrieved from one or more data sources (e.g., remote database 120).

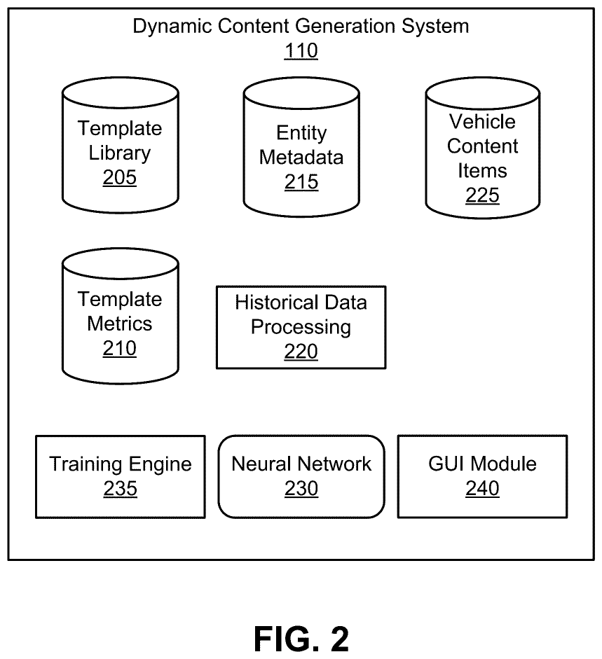

Responsive to the user providing an indication to dynamically populate the selected template (e.g., by clicking a displayed button), the electronic communication augmentation system 110 uses the trained machine learning model to generate a plurality of vehicle content item recommendations (corresponding to vehicle content items such as vehicle information, multimedia relating to a vehicle, a quote for a vehicle, etc.), retrieves vehicle content items based upon the generated recommendations, and automatically populates the fields of the template. The email containing populated content item fields may then be sent to the entity. Additional details relating to the electronic communication augmentation system 110 are described in further detail in the description of FIG. 2.

Remote database 120 stores data for use by the electronic communication augmentation system 110 for populating fields of an electronic communication with vehicle content items, such as one or more templates, information pertaining to one or more vehicles (e.g., attributes and values corresponding to vehicles, content items associated with the one or more vehicles, etc.), entity metadata (e.g., data associated with a current interaction with an entity, data associated with previous interactions with the entity, historical data associated with a plurality of additional entities, etc.), and/or the like. In some embodiments, data may include data generated by the trained machine learning model (e.g., records of previous content item recommendations generated by the trained machine learning model for populating fields of an electronic communication), and records of further activities by an entity responsive to receiving an electronic communication. User device 130 and electronic communication augmentation system 110 may transmit data to database 120 for storage, and data stored in remote database 120 may be queried by electronic communication augmentation system 110. In some embodiments, data is stored in a data structure such that data may be queried using an identifier (e.g., a key for a key-value pair).

In some embodiments, the remote database 120 may receive data from third parties over network 140. These may include vehicle attributes and values, e.g., vehicle construction information, vehicle operation information, vehicle performance information, identification information, appearance information, or any other information describing a vehicle. In addition, the received third party data may include historical activity relating to one or more entities (e.g., previous interactions between the third party and one or more entities, information indicating an affinity of the one or more entities, etc.).

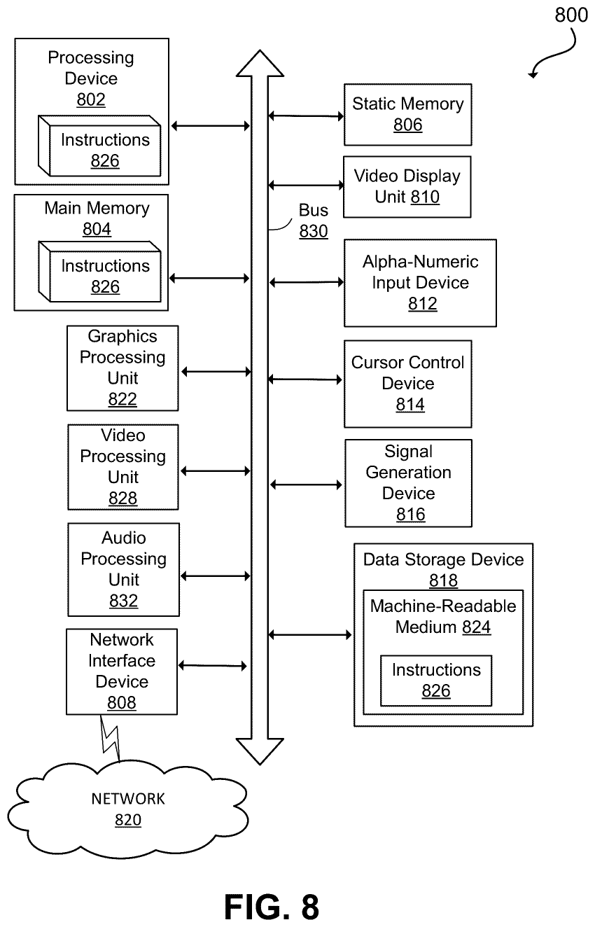

User device 130 is an example of a computing device for a user to generate and sent electronic communications to one or more entities, the electronic communications containing vehicle content items dynamically populated using the electronic communication augmentation system 110. For example, the user device 130 may communicate with the electronic communication augmentation system 110 to display on the user device 130 an interface to specify an entity for which to send an electronic communication to, specify a template to be associated with an electronic communication, accept or reject content items to be included in the electronic communication based on content item recommendations generated by the content creation system, preview an electronic communication having one or more accepted content items prior to transmittal to the entity, view data associated with previous electronic communications, view data associated with prior interactions with the entity, or some combination thereof. In some embodiments, the computing device is a conventional computer system, such as a desktop or a laptop computer. Alternatively, the computing device may be a device having computer functionality, such as a personal digital assistant (PDA), a mobile telephone, a smartphone, or another suitable device. The computing device is configured to communicate with electronic communication augmentation system 110 via network 140, for example using a native application executed by the computing device and provides functionality of electronic communication augmentation system 110, or through an application programming interface (API) running on a native operating system of the computing device, such as IOS® or ANDROID™. Some or all of the components of a computing device are illustrated in FIG. 8.

The network 140 may serve to communicatively couple remote electronic communication augmentation system 110, remote database 120, and user device 130. For example, the electronic communication augmentation system 110 and the user device 130 are configured to communicate via the network 140. In some embodiments, the network 140 includes any combination of local area and/or wide area networks, using wired and/or wireless communication systems. The network 140 may use standard communications technologies and/or protocols. For example, the network 140 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 140 may be encrypted using any suitable technique or techniques.

### Electronic Communication Augmentation System

FIG. 2 is a block diagram of electronic communication augmentation system 110 of FIG. 1, in accordance with at least one embodiment. Electronic communication augmentation system 110 includes or accesses a template library 205, template metrics store 210, entity metadata store 215, historical data processing module 220, vehicle content item store 225, neural network 230, training engine 235, and GUI module 240. Electronic communication augmentation system 110 includes one or more machine learning models such as a neural network 230. Electronic communication augmentation system 110 may have alternative configurations than shown in FIG. 2, including different, fewer, or additional components. For example, in some embodiments, the electronic communication augmentation system 110 may include additional models, such as additional machine learning models for processing entity historical data to generate entity affinities, or to generation similarity metrics between different entities, etc. In some embodiments, at least some of the components of electronic communication augmentation system 110 may be implemented as part of the remote database 120 illustrated in FIG. 1 that is accessible to the electronic communication augmentation system 110, or as part of the user device 130. For example, in some embodiments, components of the electronic communication augmentation system 110 may be implemented as part of an application downloaded to the user device 130, or accessed by the user device 130 via a browser.

The template library 205 stores templates usable for populating an electronic communication with content items. Each template may be associated with particular types of interactions (e.g., whether the interaction pertains to a vehicle or a service agreement for a vehicle) or an interaction state or context (e.g., if the entity has expressed initial interest in a vehicle, or if the entity is close to closing a deal on a vehicle). For example, in some embodiments, the template library 205 may store a first template containing fields to be populated by content items associated with a plurality of different vehicles, and a second template containing fields to be populated by content items for providing more detailed information regarding a specific vehicle, the first and second templates being associated with different interaction states, e.g., corresponding to an entity expressing a general interest in particular types of vehicle, or more specific interest in a particular model of vehicle. In some embodiments, a template may contain fields corresponding to content items drawn from different sources. For example, the template library 205 may store templates corresponding to an interaction state corresponding to a more advanced stage of discussion, containing a first set of fields associated with content items to be retrieved from a vehicle attribute store corresponding to attribute information for a particular vehicle, a second set of fields associated with content items from a dealer management system (DMS) configured to provide availability information for the particular vehicle (e.g., access inventory of particular types of vehicles from dealer databases based on location, where an urgency notification may be displayed based on the accessed inventory).

In some embodiments, a template may specify one or more fields corresponding to another template (also referred to as a “sub-template”). For example, a first template may specify one or more fields corresponding to different aspects of a vehicle, to be filled in accordance with at least one selected sub-template associated with specific vehicle aspects (e.g., a sub-template associated with information on vehicle interior, or a sub-template associated with information on vehicle safety features), selected using the trained machine learning model based upon entity metadata. In some embodiments, a template may contain a plurality of sub-template fields. For example, a template may contain a first sub-template field and a second sub-template field corresponding to templates for displaying vehicle interior features and vehicle exterior features, wherein the mapping of which template is used to populate which sub-template field is determined based upon entity metadata (e.g., whether the entity has a greater affinity or interest in the interior features of a vehicle versus exterior features, where content for the sub-template associated with great affinity may be mapped to the first sub-template field).

In some embodiments, the electronic communication augmentation system 110 receives data specifying one or more parameters for creating a new template (e.g., from a user via a displayed user interface), creates the new template based on the received parameters, and stores the new template in the template library 205. For example, the electronic communication augmentation system 110 may generate a template creation interface to be displayed to a user, with which the user may specify one or more fields to be associated with the template, placement of the one or more fields within the template, and/or content items associated with each field (e.g., type of content item such as text, multi-media, sub-templates, etc., and/or whether the content item for a field is associated with any particular vehicle aspects).

The template metrics store 210 stores statistical metrics associated with the templates of the template library 205. In some embodiments, each template stored in the template store 205 is associated with a unique identifier, which may be used to trace performance of the template. For example, electronic communications generated using each template may be tracked, and actions by entities in response to received electronic communications can be analyzed to determine statistics for each template (e.g., a performance score indicating how many electronic communications where a particular template was used where successfully delivered to the entity, opened by the entity, resulted in a closed deal with the entity, etc.). In some embodiments, the template metrics store 210 is configured to track statistics relating to each template, which may be displayed to the user when selecting a template to be used for an electronic communication.

The entity metadata store 215 stores attributes and values corresponding to various entities. In some embodiments, entity metadata is generated based upon interactions between the entity and a DMS, and may include information such as entity name, entity demographics, entity interests or affinities, etc. In some embodiments, entity metadata includes data explicitly provided by the entity (e.g., the entity providing a name and demographic information when registering with the DMS). In addition, the entity metadata may include data inferred based upon tracked activities of the entity (e.g., generated based upon historical data relating to the entity).

In some embodiments, the entity metadata store 215 also stores historical data of a plurality of entities. Historical data for an entity may be gathered from multiple sources, which may include past direct interactions by the DMS with entity (e.g., previous electronic communications sent to entity, responses to electronic communications, previous vehicles purchased by entity, service contracts purchased by entity, types of financing used, etc.), passive interactions by the entity (e.g., tracking how long and/or how often an entity views certain types of content), and historical data relating to the entity received from 3^{rd} parties. For example, in some embodiments, interactions between an entity and one or more third-party websites may be tracked using a tracking pixel and recorded as historical data for the entity (e.g., frequency and duration at which the entity views specific third-party web pages, purchases by the entity through third-party web pages, etc.). In some embodiments, the historical data store 215 may receive historical data relating to one or more entities directly from one or more third parties.

The historical data processing module 220 is configured to analyze historical data collected in the entity metadata store 215 to generate aggregated entity metadata. In some embodiments, the historical data processing module 220 analyzes the historical data to determine one or more affinities of an entity. As used herein, an affinity may refer to a level of interest expressed by the entity relating to a vehicle, an aspect of a vehicle, an aspect of a deal relating to a vehicle, and/or the like. For example, affinities of an entity may indicate categories of vehicles are of interest to the entity (e.g., vehicle type such sedans, crossovers, etc., or vehicle manufacturer such as vehicles by Toyota, etc.), which aspects of a vehicle are most of interest to the entity (e.g., whether the entity is most interested in interior features, exterior features, safety features, etc.), vehicle acquisition methods of interest to the entity (e.g., all cash, with financing, etc.). In some embodiments, each affinity is associated with an affinity score indicating a strength of the affinity. For example, the affinity scores of an entity may indicate that an entity is interested in both external appearance and safety features of a vehicle, but prioritizes safety features over external appearance.

In some embodiments, the historical data processing module 220 filters the historical data associated with an entity when determining affinities relating to the entity. For example, in some embodiments, the historical data processing module 220 may automatically expire certain types of historical data that exceeds a threshold age (e.g., over one year old), if conflicting or overriding data is received (e.g., historical data indicating that an entity prefers leasing a vehicle, following a change in entity status indicating that the entity now prefers to purchase a vehicle outright), or some combination thereof.

In some embodiments, the historical data processing module 220 may generate, for each entity, one or more vectors representing entity metadata of the entity. Each vector may represent a subset of historical data associated with the entity, and/or affinities determined based upon the historical data of the entity, or some combination thereof. In some embodiments, the data represented by the vector may be selected based upon an interaction state associated with the entity and/or a neural network model the vector is to be used for. In some embodiments, each entity may be associated with a plurality of different vectors corresponding different potential interaction states, where each vector represents a different set of data associated with the entity (e.g., raw historical data and/or affinities data determined to be most relevant to a given interaction state). In some embodiments, each entity is associated with a plurality of vectors corresponding to different types of affinities, such as a first vector associated with affinities relating to physical aspects or features of one or more vehicles, a second vector associated with affinities relating to service contracts for vehicles, a third vector relating to financing for vehicles, etc. In some embodiments, the generated vectors may be used to compare different entities and determine, for a particular entity, similar entities (e.g., entities exhibiting similar historical behavior, entities having similar affinities).

In some embodiments, the historical data processing module 220 is also configured to select entity metadata to be used by the neural network 230 (described below) for generating content item recommendations for a given electronic communication. Based upon the interaction state and/or template associated with the electronic communication, different types of entity metadata may be used in generating content item recommendations. For example, if the current state of an interaction with an entity is associated with a specific vehicle (e.g., the state of the interactions corresponds to an advanced state of a deal for the entity to purchase a specific type of vehicle, or the interaction relates to a service contract for a specific vehicle owned by the entity), entity metadata relating to affinities of the entity for other types of vehicles may be excluded. Similarly, if the state of the interaction relates to leasing a vehicle, entity metadata relating to other types of financing may not need to be considered. In some embodiments, the historical data processing module 220 maintains mappings between different interaction states and/or templates to types of entity metadata to be used for generating content item recommendations for electronic communications, and selects data corresponding to the entity to which the electronic communication is to be sent based upon a current interaction state and/or a template selected by the user. By reducing dimensionality of the historical data to be input to the neural network, accuracy and efficiency of the neural network may be improved, and allows for the use of training data with more limited information, while still enabling the neural network to be trained to yield accurate results.

The vehicle content item store 225 accesses, manages, and/or maintains one or more content items stores storing content items pertaining to one or more vehicles. The content items may correspond to text, multimedia (e.g., pictures, audio, video, etc.), data visualizations (e.g., graphs, charts, etc.), or some combination thereof. Each content item may correspond to a specific vehicle (e.g., make and model) or type of vehicle, and may be associated with one or more specific aspects of a vehicle. For example, the content item may include text or multimedia describing one or more performance metrics of a particular vehicle, interior or exterior features of the vehicle, safety features of the vehicle, available configurations of the vehicle, etc. In some embodiments, the vehicle content item store 225 may also store content items relating to vehicle acquisition (e.g., financing options for the vehicle, leasing options for the vehicle, etc.), vehicle service (e.g., service plans available for the vehicle).

The vehicle content items stored in the vehicle content item store 225 are associated with specific vehicles and/or vehicle attributes. For example, a vehicle having certain safety features may be associated with textual content items describing the vehicle's safety features and/or multimedia content items depicting the safety features of the vehicle. Different sets of content items may be associated with different configurations of the same type of vehicle (e.g., different colors, different trim levels, etc.). By storing and maintaining content items associated with different attributes and configurations of each vehicle, the electronic communication augmentation system 110 is able to include vehicle content items in electronic communications that align with the affinities of different entities. For example, an entity determined to have a strong affinity for red vehicles may be sent an electronic communication having multimedia content items that only depict red-colored vehicles.

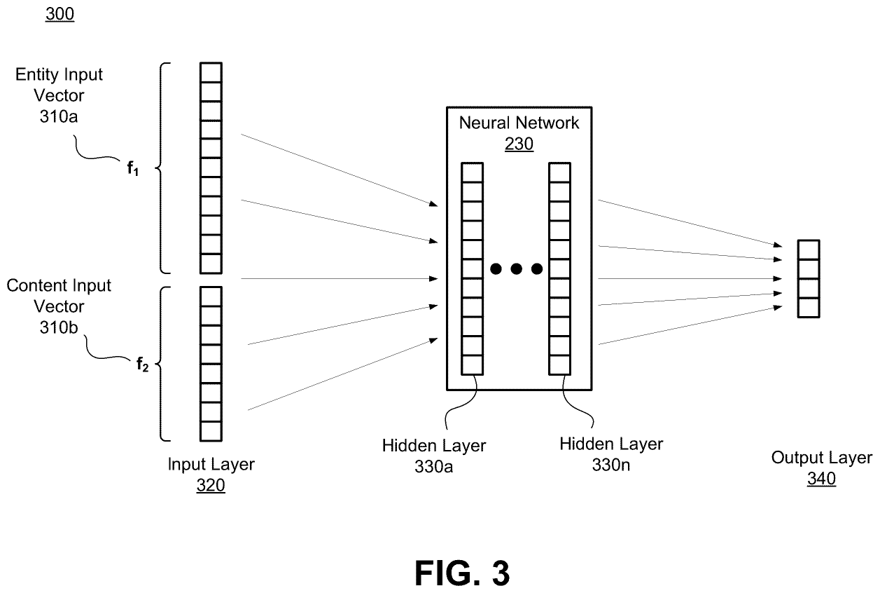

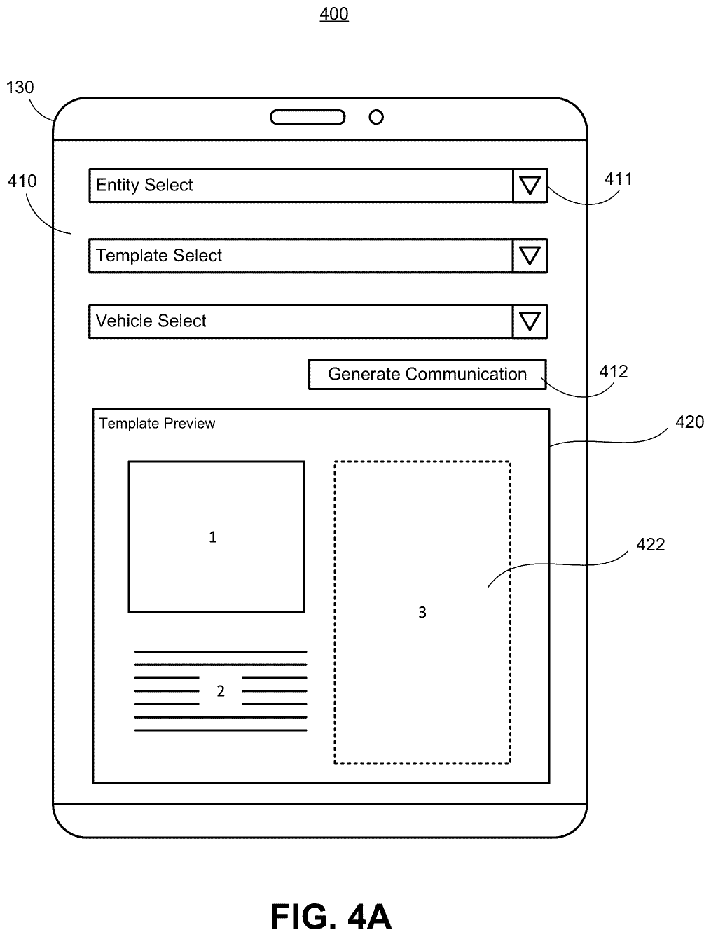

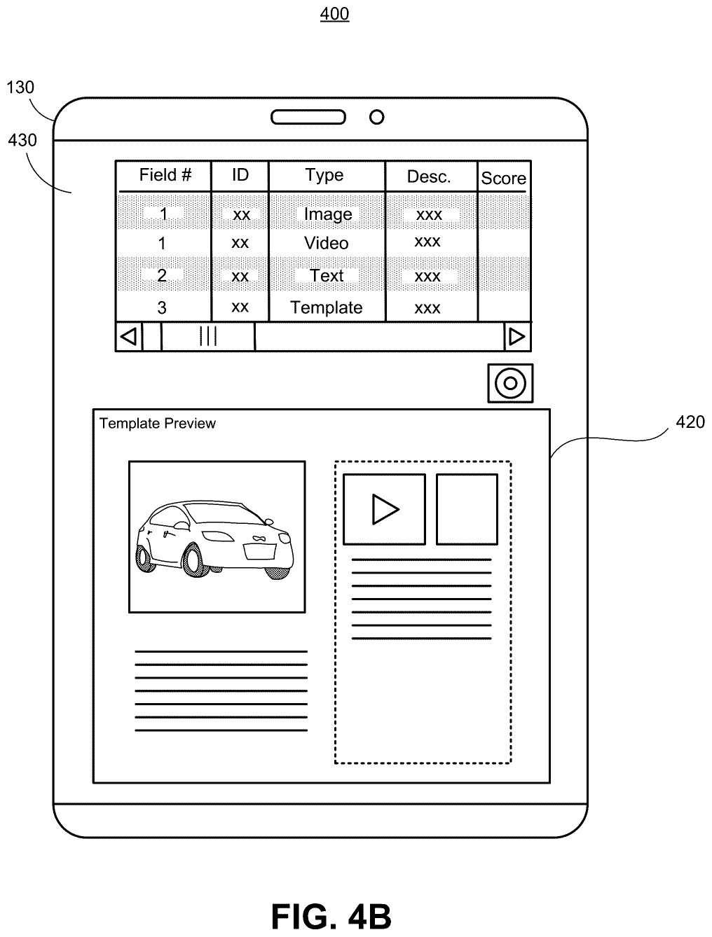

The neural network 230 generates content item recommendations for an electronic communication to an entity. For example, neural network 230 may generate content item recommendations for specific vehicle content items stored in the vehicle content item store 225, based upon a selected template and entity metadata associated with the entity. Neural network 230 includes various layers such as hidden layers, where each hidden layer includes hidden nodes. Neural network 230 may be trained by training engine 235. For example, training engine 235 uses training data comprising information associated with electronic communications transmitted to a plurality of entities (e.g., content items of the electronic communications, templates associated with the electronic communications, interaction state associated with the electronic communication), recorded results of the electronic communications (e.g., actions taken by the plurality of entities responsive to the electronic communications), and information associated with the plurality of entities (e.g., entity metadata) to determine weights associated with connections between the hidden nodes to such that the content item recommendations generated by neural network 230 are likely to, when used to populate fields of an electronic communication sent to an entity, illicit a desired result from the entity. Neural network 230 is further described in the description of FIG. 3. Example processes for generating content item recommendations and training the neural network are described in the descriptions of FIGS. 4 and 6-7.

In some embodiments, the neural network may comprise multiple different neural networks trained using different subsets of the historical data associated with different types of interactions or interaction states. For example, in some embodiments, the neural network may comprise a first neural network associated with a first interaction state and trained using first types of entity metadata, and a second neural network associated with a second interaction state and trained using second type of entity metadata. This may allow for the neural networks to be trained more efficiently, by reducing the amount of data needed for training, and allow for each neural network to be tailored for specific situations (e.g., specific interaction states). For example, in some embodiments, a first neural network tailored to recommend content items for communications associated with an interaction state where the entity has expressed initial interest in a vehicle may be trained using vectors representing entity metadata relating to entity interest in particular vehicle types, particular vehicle features, etc., and to output content item recommendations relating to vehicle information. On the other hand, a second neural network tailored to recommend content items for communications associated with an interaction state corresponding to a finalizing deal state may be trained using vectors representing entity metadata relating to pricing, financing options, etc. In addition, because the neural network is trained to receive an indication of a template specifying a specific arrangement of fields and types of content items that may be used to populate its fields, the neural network may be restricted in the number and type of content item recommendations that it may output, reducing an amount of computation needed to be performed by the neural network in generating content item recommendations.

The training engine 235 trains neural network 230 to receive an input vector that indicates at least a selected template to be used for an electronic communication, and metadata associated with an entity to which the electronic communication is to be sent, and to output one or more content item recommendations corresponding to fields of the selected template. In some embodiments, the metadata may correspond a vector generated by the historical data processing module 220 representing entity metadata of the entity. The training engine 235 accesses training data comprising information associated with previously sent electronic communications (e.g., indicating a template used for each communication, content items selected to populate the fields of the template, etc.), metadata corresponding to entities that the electronic communications were sent to (e.g., entity attributes, historical data, affinities, etc., and/or metadata vectors generated by the historical data processing module 220), and results data (e.g., indicating subsequent actions by the entities responsive to receipt of the electronic communications), and uses the training data to adjust the neural network 230 to produce content item recommendations that are expected to, based on the results data, maximize a probability that the entity receiving an electronic communication populated using the recommended content items will perform one or more desired subsequent actions, based on the type of interaction with the entity (e.g., make a purchase, inquire about a next stage of a deal, renew a service contract, etc.). In some embodiments, each piece of training data is associated with an identifier indicating an entity that the data is associated with. In some embodiments, training engine 235 adjusts neural network 230 by adjusting a dimension of a hidden layer of neural network 230, or by adjusting weights of nodes of hidden layers of neural network 230. In some embodiments, training engine 235 uses an error metric of a mean additive error.

In some embodiments, the neural network 230 is trained to recommend vehicle content items based upon affinities of the entity, by analyzing types of recommended content items that, when used in electronic communications to similar entities (e.g., entities with similar affinities, associated with similar interaction states, and/or the like), resulted in different types of subsequent actions by the receiving entity. For example, if the entity's affinities indicate that the entity is primarily interested in certain aspects of a vehicle (e.g., interior features), the neural network 230 may recommend content items relating to those aspects based upon the determined affinities and the current interaction state (e.g., content items describing the interior features of multiple different vehicle models, content items describing interior feature options of a specific vehicle model, or some combination thereof, depending on the interaction state).

In some embodiments, each content item recommendation generated by the neural network 230 may be associated with a recommendation score. The neural network 230 may be trained to generate the recommendation score to indicate a confidence level that the content item, if included in an electronic communication to the entity, may result in a desired subsequent action by the entity.

In some embodiments, as additional electronic communications are sent out and results data is received, the training engine 235 may generate updated training data, and may retrain the neural network 230. In some embodiments, re-training may be performed periodically, responsive to user input, when a threshold amount of new training data is generated, when one or more tracked metrics (e.g., analyzing entity responses to electronic communications to determine a success rate or score) fall below a threshold amount, or some combination thereof.

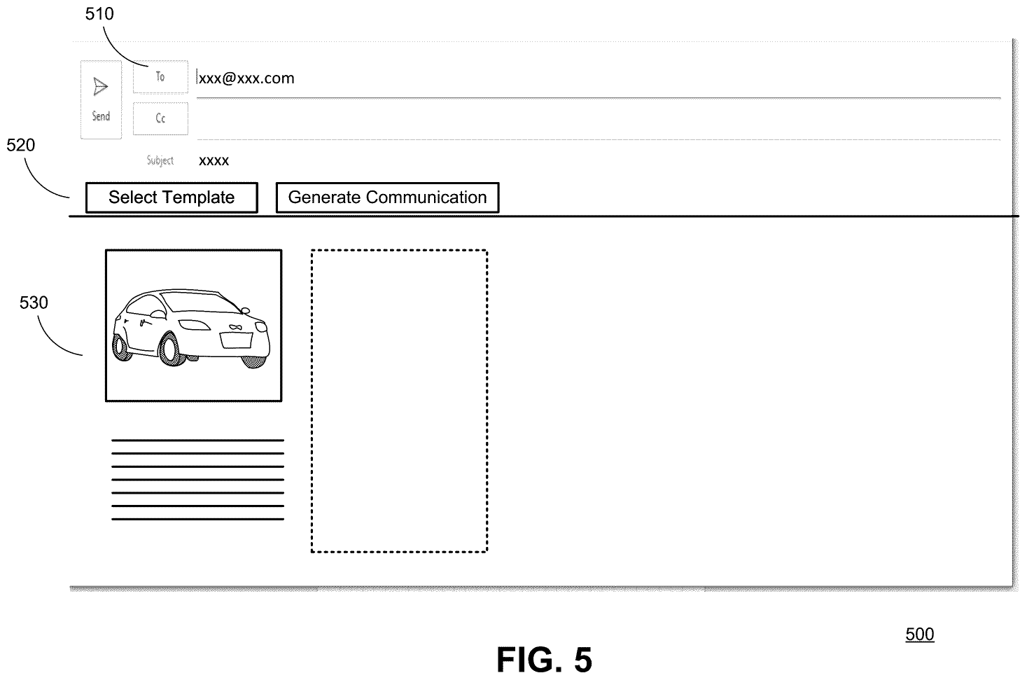

The GUI module 240 provides for display GUIs through which a user can manage or use the functions of electronic communication augmentation system 110. To provide a GUI for display, GUI module 240 may host documents (e.g., HyperText Markup Language (HTML) documents) and transmit them to a web browser or application of the user device 130 that generates the GUI at the device 130. In some embodiments, GUI module 240 generates for display a GUI on a computing device (e.g., user device 130) that is communicatively coupled to electronic communication augmentation system 110. GUI module 240 may provide an interactive user interface that includes various buttons, toggles, menus, etc. through which a user can query vehicles and specify parameters for querying the vehicles. FIGS. 4A, 4B, and 5 shows example GUIs that may be generated by GUI module 240.

GUI module 240 may receive a request to generate an electronic communication to transmitted to an entity. In some embodiments, the request indicates an identifier of an entity as an intended recipient of the communication, an indication of a current interaction of the entity, a template to be used for the communication, and/or the like. For example, a user of user device 130 uses a GUI to specify an identifier of an entity for which an electronic communication is to be sent, such as an email address associated with entity, where this specification is received by GUI module 240. The GUI module 240, responsive to receiving the identifier, may interface with the entity metadata store 215 and template library 205 to display one or more templates selectable by the user for the electronic communication. For example, the identifier may be used to determine a context of an interaction with the entity using the entity metadata store 215, which may then be used to select one or more candidate templates from the template library 205. In some embodiments, the one or more candidate templates may be displayed to the user sorted by one or more template metrics maintained by the template metrics store 210.

Responsive to the user selecting a particular template, the selected template, along with metadata associated with the entity may be used to generate an input vector for the neural network 230, which generates one or more content item recommendations to be displayed to the user using the GUI module 240. For example, the GUI module 240 may display the generated recommendations ranked based on recommendation scores, as a list or chart, and/or may display a preview of an electronic communication with template fields auto-populated using recommended content items having the highest recommendation scores for each field. GUI module 240 may receive user input interacting with the displayed recommendations. For example, the GUI module 240 may receive a user selection of one or more recommendations to populate fields of the template with recommended content items.

### Electronic Communication Augmentation System Models and Applications

FIG. 3 shows diagram 300 of example neural network 230 maintained by a content creation system, in accordance with at least one embodiment. Neural network 230 includes input layer 320, one or more hidden layers 330a-n, and output layer 340. Each layer of neural network 230 (i.e., input layer 320, output layer 340, and hidden layers 330a-n) comprises a set of nodes such that the set of nodes of input layer 320 are input nodes of neural network 230, the set of nodes of output layer 340 are output nodes of neural network 230, and the set of nodes of each of hidden layers 330a-n are hidden nodes of neural network 230. Generally, nodes of a layer may provide input to another layer and may receive input from another layer. Nodes of each hidden layer are associated with two layers, a previous layer, and a next layer. The hidden layer receives the output of the previous layer as input and provides the output generated by the hidden layer as input to the next layer.

Each node has one or more inputs and one or more outputs. Each of the one or more inputs to a node comprises a connection to an adjacent node in a previous layer and an output of a node comprises a connection to each of the one or more nodes in a next layer. That is, each of the one or more outputs of the node is an input to a node in the next layer such that each of the node is connected to every node in the next layer via its output and is connected to every node in the previous layer via its input. Here, the output of a node is defined by an activation function that applies a set of weights to the inputs of the nodes of neural network 230. Example activation functions include an identity function, a binary step function, a logistic function, a TanH function, an ArcTan function, a rectilinear function, or any combination thereof. Generally, an activation function is any non-linear function capable of providing a smooth transition in the output of a neuron as the one or more input values of a neuron change. In various embodiments, the output of a node is associated with a set of instructions corresponding to the computation performed by the node. Here, the set of instructions corresponding to the plurality of nodes of the neural network may be executed by one or more computer processors.

In one embodiment, the input layer 320 receives one or more input vectors 310, which may include an entity input vector 310a and a content input vector 310b. The entity input vector 310a is a vector comprising attributes associated with an entity and an interaction with an entity that can be analyzed by electronic communication augmentation system 110. For example, entity input vector 310a may comprise attributes of the entity, current state of the interaction, historical information associated with the entity (e.g., past interactions with the entity, historical information received via third parties, etc.), or any combination thereof. As discussed above, in some embodiments, the data represented by the entity input vector 310a may be selected based upon the current interaction state. For example, each entity may be associated with multiple different vectors associated with different interactions states and/or affinities, where the entity input vector 310a is selected from the different vectors based on the current interaction state associated with the entity.

The content input vector 310b corresponds to one or more vectors comprising attributes associated with content items from the vehicle content item store 225. For example, the content input vector 310b may represent metadata associated with a content item, such as type of content item (e.g., text, graphics, etc.), vehicle associated with the content item, vehicle aspects associated with the content item (e.g., physical aspects, features, financing or servicing options, etc.). In some embodiments, the content input vector 310b may be selected based upon the current interaction state, a selected template, or some combination thereof. For example, in some embodiments, a selected template may indicate a number and type of content items to be recommended, which is used to select content input vectors 310b.

Neural network 230 generates a numerical vector representation of input vectors 310, where this numerical vector representation is referred to as an embedding. Each of the hidden layers 330a-330n of neural network 230 also generates intermediate embeddings. The embeddings are a representation of the input vector mapped to a latent space. The latent space may be a compressed representation of the entity data of input vector 310. The connections between nodes in neural network 230 each include a weight. In one or more embodiments, training neural network 230 comprises adjusting values for weights of neural network 230 to minimize or reduce a loss function associated with neural network 230. Neural network 230 may be re-trained using user feedback or the loss function, where the re-training modifies the dimension of the latent space or the values of weights in neural network 230. For example, in some embodiments, the neural network 230 is trained to output, at the output layer 340, one or more scores corresponding to content items associated with the content input vector 310b, where each score a is recommendation score to indicate a confidence level that the content item, if included in an electronic communication to the entity represented by the entity input vector 310a, may result in a desired subsequent action by the entity. During training, the output score may be compared with historical information associated with previously sent communications (e.g., content items included in communication, subsequent actions by entity, etc.) to generate the loss function.

The term “vector” as used herein is not necessarily limited to a representation of either one column or one row, and may also refer to a matrix having both more than one column and row unless implied otherwise by context. Input vector 310 may include one or more columns for each of one or more entity attributes (e.g., entity metadata and/or historical data) and various rows for unique values of the respective attributes. In some embodiments, the neural network 230 may modify (e.g., reduce) the dimension of input vector 310 as it provides data from one layer to the next, e.g., to achieve a reduced number of entity attributes representative of entity affinities and behavior. This may potentially reduce an amount of processing needed by the neural network 230 to determine content item recommendations based on the attributes of the entity.

In some embodiments, the training engine 235 of electronic communication augmentation system 110 may determine which pieces of entity data are input into neural network 230 using the historical data processing module 215, user feedback, a loss function, or combination thereof. For example, historical data processing module 215 may perform an attribute selection to choose entity metadata associated with a particular interaction state and/or template for generating an electronic communication. Electronic communication augmentation system 110 can iteratively select attributes, apply neural network 230 to the selected attributes, and determine an error metric until the error metric or trend in iteratively determined error metrics meets a predetermined criterion. For example, electronic communication augmentation system 110 can select a different set of entity metadata, apply neural network 230 to the different set of entity metadata, determine a corresponding error metric, and determine a difference between the two error metrics.

### Example Electronic Communication Augmentation System Interface

FIGS. 4A and 4B depict a graphical user interface (GUI) for generating electronic communications, in accordance with at least one embodiment. Electronic communication augmentation system 110 may provide interface 400 for display on user devices (e.g., user device 130). Interface 400 includes a parameter selection panel 410, and a template preview panel 420. The parameter selection panel 410 includes one or more user input elements 411 usable by the user to select one or more parameters for generating an electronic communication. For example, the user input elements 411 may include elements allowing a user to select a particular entity as an intended recipient of the electronic communication, and a template for the electronic communication. In some embodiments, the user input elements 411 may also allow the user to select one or more vehicle attributes (e.g., a specific vehicle model) associated to be associated with the electronic communication. This may be done to limit the types of content items that will be recommended by the neural network.

In some embodiments, instead of being selected by the user, the electronic communication augmentation system 110 automatically selects one or more of the parameters for generating the electronic communication. For example, in some embodiments, responsive to receiving a selection of a particular entity, the electronic communication augmentation system 110 identifies a current interaction state associated with the entity, and automatically selects a template to be used for the electronic communication based on the current interaction state. In some embodiments, the electronic communication augmentation system 110 may, responsive to identifying a current interaction state associated with the entity, allow the user to select between a plurality of candidate templates associated with the identified interaction state, allowing for the user to more easily select a relevant template for the electronic communication. In addition, the electronic communication augmentation system 110 may, based on the entity and current interaction state, identify one or more vehicle attributes to be associated with the electronic communication. In some embodiments, the vehicle attribute selection may be left blank, allowing for the neural network to recommend content items based on entity metadata without restriction.

The template preview panel 420 displays a preview of a selected template, allowing for the user to view a format of an electronic communication generated using the selected template. The template preview panel 420 may display a plurality of fields 422 associated with the template, and an indication of a type of content item to be used to populate each field. For example, as shown in FIG. 4A, the template preview panel 420 may show that a selected template includes a first field for a multimedia content item, a second field for text, and a third field corresponding to a sub-template.

When the user is satisfied with their selections, the user may confirm their selections by selecting a button 412 to generate the electronic communication, whereupon the electronic communication augmentation system 110 constructs an input vector based on the selected entity and template, and uses a neural network to process the input vector to generate content item recommendations for generating the electronic communications.

FIG. 4B depicts the GUI for generating electronic communications, after the neural network has generated content item recommendations for the electronic communication, in accordance with at least one embodiment. The GUI may display a content item recommendations table 430 (e.g., in place of the parameter selection panel 410, as shown in FIG. 4B, or in a separate area of the display) that indicates content item recommendations generated by the neural network. The content item recommendations table 430 may indicate, for each recommendation, a field of the template for which the content item recommendation applies to, an identifier of the recommendation content item (e.g., content item name, identification number, etc.), an indication of a type of the content item (e.g., text, multimedia, sub-template, etc.), a recommendation score associated with the content item, description of the content item, or any combination thereof. In some embodiments, the content item recommendations may include a recommendation of a set of content items (e.g., a first content item for a first field and a second content item for a second field), where the content items of the set are related (e.g., an image content item for the first field depicting an aspect of a vehicle described in a textual content item for the second field).

The content item recommendations table 430 may be interactive. For example, GUI module 240 may enable a user to sort, filter, or select entries within content item recommendations table 430. For example, in some embodiments, the GUI module 240 may, responsive to the user selecting a recommended content item for a particular field, generate instructions to populate a preview of the content item into the template that is displayed in the template preview panel 420. In some embodiments, if a content item recommendation corresponds to a sub-template, selecting the recommendation may cause the selected recommendation to expand into a sub-table displaying content item recommendations for fields of the selected sub-template. Once the user has selected a content item recommendation for each field of the template, the user may confirm their selections, upon which an electronic communication populated using content items corresponding to the selected recommendations may be generated and transmitted. In some embodiments, the user may reject the recommendations generated for a particular field, and instead specify a particular content item to be used for the field in lieu of any of the recommendations generated by the neural network.

Although FIGS. 4A and 4B illustrate specific examples of GUIs that may be used to generate electronic communications, it is understood that it other embodiments, different GUIs with different features may be used. For example, in some embodiments, the content item recommendations table 430 may be displayed as a plurality of tables, each corresponding to a different field of the selected template, allowing the user to more easily select a particular recommendation for each field of the template.

In some embodiments, the GUI generated by the GUI module 240 may be implemented as part of a separate application (e.g., as a plug-in for an email application such as Microsoft Outlook). FIG. 5 illustrates an example of a GUI 500 for generating electronic communications implemented as a plug-in for an email application, in accordance with at least one embodiment. For example, as illustrated in FIG. 5, the user may begin generation of an electronic communication by drafting an email message to a desired entity (e.g., by typing an email address associated with the entity in the “To:” field 510 of an email message). The GUI contains a toolbar 520 where the user may further select a template to be used for the electronic communication. In some embodiments, the electronic communication augmentation system 110 may automatically use the email address specified by the user to identify an entity and a current interaction state, to generate a list of one or more candidate templates from which the user may select using the toolbar 520. In some embodiments, the GUI is configured to, when the user selects a template, display a preview of the template in the body of the email 530. In addition, once the user confirms their selected template (e.g., by clicking a confirmation or “generate communication” button is the displayed toolbar 520), the GUI may display a content item recommendation table (not shown) allowing the user to select content items for which to populate the fields of the selected template.

### Processes for Content Item Selection in an Electronic Communication Augmentation System

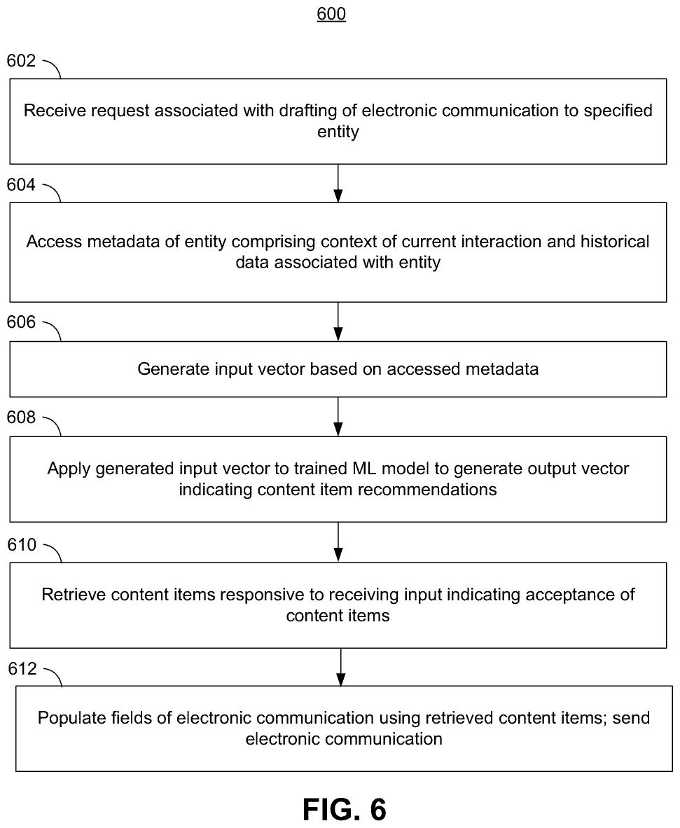

FIG. 6 is a flowchart illustrating a process for automatically populating fields of an electronic communication with content items, in accordance with at least one embodiment. Electronic communication augmentation system 110 may perform process 600. In some embodiments, electronic communication augmentation system 110 performs operations of process 600 in parallel or in different orders, or may perform different steps.

Electronic communication augmentation system 110 receives 602 a request associated with the drafting of an electronic communication to a specific entity. In some embodiments, the request includes an input by a user specifying an entity to which to send the electronic communication to. In some embodiments, the request may further specify an interaction context associated with the entity, and/or a template for the electronic communication containing one or more content item fields. In some embodiments, the electronic communication augmentation system may identify, based on the specified entity, the interaction context and one or more templates associated with the interaction context from which the user may select.

Electronic communication augmentation system 110 accesses 604 metadata of entity comprising context of current interaction and historical data associated with entity. In some embodiments, the historical data corresponds to data generated based upon one or more previous interactions of the entity relating to one or more vehicles, and may include direct interactions, passive interactions, and/or interactions with third parties.

Electronic communication augmentation system 110 generates 606 input vector based on accessed metadata. In some embodiments, the electronic communication augmentation system accesses an entity metadata store, and selects entity metadata comprising historical data based upon the interaction context and/or template associated with the electronic communication for which to generate the input vector. For example, the historical data associated with the entity may be selected for generating the input vector based on whether the current interaction context relates to a vehicle or a service contract associated with a vehicle.

Electronic communication augmentation system 110 applies 608 generated input vector to trained ML model to generate output vector indicating content item recommendations. In some embodiments, the output vector indicates a plurality of content item recommendations pertaining to a selected vehicle of the one or more vehicles. In some embodiments, the types of content item recommendations indicated in the output vector are based on the context of the interaction and/or on a selected template associated with the electronic communication, and may correspond to textual content items, multimedia content items, or some combination thereof. For example, in some embodiments, at least one content item recommendation of the plurality of content item recommendations corresponds to a multimedia content item of the selected vehicle, associated with a particular field of the selected template.

Electronic communication augmentation system 110 retrieves 610 content items responsive to receiving input indicating acceptance of content items. In some embodiments, the electronic communication augmentation system 110 generates a GUI in the user is presented with a list or table of the generated content item recommendations, wherein the GUI includes interactive elements allowing the user to review, accept, and/or reject the generated recommendations. In some embodiments, the GUI is configured to, responsive to the user selecting a particular recommendation, display a preview of the content item populated on a corresponding field of the template as specified by the generated recommendation.

Electronic communication augmentation system 110 populates 612 fields of electronic communication using the retrieved content items, and sends the electronic communication. In some embodiments, the electronic communication with populated content items may be displayed to the user for review, along with interactive elements allowing to the user to instruct that the electronic communication be transmitted, or change the content items populating one or more fields.

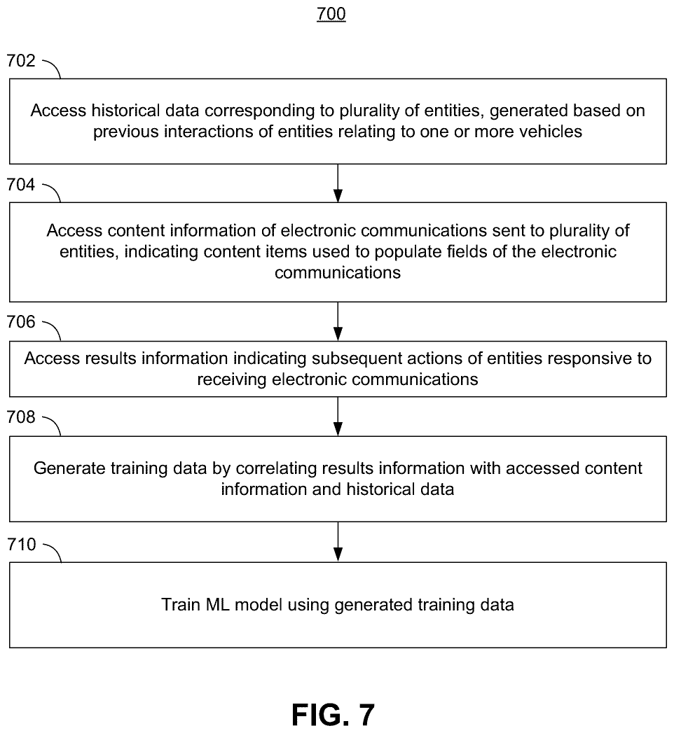

FIG. 7 is a flowchart illustrating a process for training a machine learning model, such as a neural network, in accordance with at least one embodiment. The process 700 may be performed by the electronic communication augmentation system 110. In some embodiments, electronic communication augmentation system 110 performs operations of process 700 in parallel or in different orders, or may perform different steps.

Electronic communication augmentation system 110 accesses 902 historical data corresponding to a plurality of entities, the historical data generated based on previous interactions of the entities relating to one or more vehicles. In some embodiments, the historical data corresponds to data generated based upon one or more previous interactions of the plurality of entities relating to one or more vehicles, and may include direct interactions, passive interactions, and/or interactions with third parties.

Electronic communication augmentation system 110 accesses 904 content information of electronic communications sent to the plurality of entities, indicating content items used to populate fields of the electronic communications. In addition, the content information may indicate an arrangement of the content items of the electronic communications (e.g., which content items mapped to which fields).

Electronic communication augmentation system 110 accesses 906 results information indicating subsequent actions of entities responsive to receiving electronic communications. In some embodiments, an electronic communication may contain a tracking link or tracking pixel usable to track one or more subsequent actions of the entity responsive to receiving the electronic communication (e.g., whether the entity selects a link to complete a purchase and/or to request additional information). In some embodiments, results information may be inferred, e.g., by attributing later interactions with the entity to the electronic communication if occurring within a threshold period of time from when the electronic communication was sent.

Electronic communication augmentation system 110 generates 908 training data by correlating results information with the accessed content information and historical data, and trains 910 the machine learning model using the generated training data.

As such, by using a neural network trained on historical data relating to a plurality of entities, the electronic communication augmentation system 110 is able to infer out contextually which vehicle or vehicle aspects an entity is interested in, pull in multimedia from different parts of platform, organize the content based upon a preconfigured template, to generate electronic communications that present content to the entity based on the entity's interests (e.g., multimedia of vehicle interior or exterior, engine, etc.)

### Computing Machine Architecture

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device 812 (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for operating a data management system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for automatically populating fields of an electronic communication with content items, comprising:
responsive to receiving a request associated with drafting an electronic communication to a specified entity, accessing metadata associated with the entity, the metadata comprising at least:
a context of a current interaction with the entity;
historical data associated with the entity, the historical data generated based upon one or more previous interactions of the entity relating to one or more vehicles;
generating an input vector based upon the accessed metadata comprising the context and at least a portion of the historical data, wherein the at least a portion of the historical data is selected from the historical data based upon the context;
applying the generated input vector to a trained machine learning model, the trained machine learning model generating an output vector indicating a plurality of content item recommendations pertaining to a selected vehicle of the one or more vehicles, wherein types of content item recommendations indicated in the output vector are based on the context of the interaction, and wherein at least one content item recommendation of the plurality of content item recommendations corresponds to a multimedia content item of the selected vehicle;
receiving an input indicating acceptance of at least a portion of the plurality of content item recommendations indicated by the generated output vector;
retrieving content items corresponding to the accepted content item recommendations; and
automatically populating one or more fields of the electronic communication using the retrieved content items.

2. The computer-implemented method of claim 1, wherein the trained machine learning model is trained by:
generating training data to train the machine learning model, by:
accessing historical data corresponding to a plurality of different entities, generated based upon previous interactions of the plurality of entities relating to one or more vehicles;
accessing content information of electronic communications sent to entities of the plurality of entities, indicating content items used to populate one or more fields in each of the electronic communications;
accessing results information indicating subsequent actions of entities of the plurality of entities responsive to receiving electronic communications;
correlating the results information with the access content information and historical data associated with the plurality of different entities to generate the training data; and
training the machine learning model using the generated training data.

3. The computer-implemented method of claim 2, further comprising:
receiving information indicating a subsequent action of the entity responsive to receipt of the electronic communication;
updating the training data based on the subsequent action; and
retraining the trained machine learning model based upon the updated training data.

4. The computer-implemented method of claim 1, wherein the historical data associated with the entity indicates an affinity between the entity and at least one aspect of the one or more vehicles.

5. The computer-implemented method of claim 4, wherein the at least one aspect of the one or more vehicles corresponds to a type of the one or vehicles, a physical aspect of the one or more vehicles, or a feature set of the one or more vehicles.

6. The computer-implemented method of claim 4, wherein the multimedia content item is selected based at least in part upon the indicated affinity.

7. The computer-implemented method of claim 1, wherein the historical data is generated using a tracking pixel configured to track interactions between the entity and one or more third-party websites, and indicates one or more affinities of the entity determined based upon interaction of the entity with the one or more third-party website.

8. The computer-implemented method of claim 1, wherein the electronic communication is associated with a template specifying the one or more fields of the electronic communication to be populated with content items.

9. The computer-implemented method of claim 8, wherein the input vector comprises an indication of the template, and wherein the trained machine learning model generates the output vector indicating the plurality of content item recommendations based upon content item types associated with the one or more fields specified by the template.

10. The computer-implemented method of claim 8, wherein the output vector further indicates an arrangement of one or more sub-templates corresponding to at least a portion of the one or more fields specified by the template, and wherein the plurality of content item recommendations indicted by the output vector are selected based upon fields specified by the one or more sub-templates.

11. The computer-implemented method of claim 8, wherein the template is selected based upon the context of the current interaction with the entity.

12. The computer-implemented method of claim 1, wherein the multimedia content item corresponds to a picture or a video depicting an aspect of the selected vehicle.

13. The computer-implemented method of claim 1, wherein the context indicates whether a type of the current interaction with the entity relates to a vehicle of the one or more vehicles or a service contract for a vehicle of the one or more vehicles.

14. The computer-implemented method of claim 1, wherein the machine learning model is a neural network comprising a plurality of hidden layers, each hidden layer comprising a plurality of hidden nodes, wherein the neural network model is trained by a determination of weights associated with connections between the plurality of hidden nodes to minimize a loss function.

15. A non-transitory computer readable medium storing program code for automatically populating fields of an electronic communication with content items, the program code comprising instructions that when executed by a processor cause the processor to:
responsive to receiving a request associated with drafting an electronic communication to a specified entity, access metadata associated with the entity, the metadata comprising at least:
a context of a current interaction with the entity;
historical data associated with the entity, the historical data generated based upon one or more previous interactions of the entity relating to one or more vehicles;
generate an input vector based upon the accessed metadata comprising the context and at least a portion of the historical data, wherein the at least a portion of the historical data is selected from the historical data based upon the context;
apply the generated input vector to a trained machine learning model, the trained machine learning model generating an output vector indicating a plurality of content item recommendations pertaining to a selected vehicle of the one or more vehicles, wherein types of content item recommendations indicated in the output vector are based on the context of the interaction, and wherein at least one content item recommendation of the plurality of content item recommendations corresponds to a multimedia content item of the selected vehicle;
receive an input indicating acceptance of at least a portion of the plurality of content item recommendations indicated by the generated output vector;
retrieve content items corresponding to the accepted content item recommendations; and
automatically populate one or more fields of the electronic communication using the retrieved content items.

16. The non-transitory computer readable medium of claim 15, wherein the trained machine learning model is trained by:
generating training data to train the machine learning model, by:
accessing historical data corresponding to a plurality of different entities, generated based upon previous interactions of the plurality of entities relating to one or more vehicles;
accessing content information of electronic communications sent to entities of the plurality of entities, indicating content items used to populate one or more fields in each of the electronic communications;
accessing results information indicating subsequent actions of entities of the plurality of entities responsive to receiving electronic communications;
correlating the results information with the access content information and historical data associated with the plurality of different entities to generate the training data; and
training the machine learning model using the generated training data.

17. The non-transitory computer readable medium of claim 15, wherein the historical data associated with the entity indicates an affinity between the entity and at least one aspect of the one or more vehicles.

18. The non-transitory computer readable medium of claim 15, wherein the electronic communication is associated with a template specifying the one or more fields of the electronic communication to be populated with content items.

19. The non-transitory computer readable medium of claim 18, wherein the input vector comprises an indication of the template, and wherein the trained machine learning model generates the output vector indicating the plurality of content item recommendations based upon content item types associated with the one or more fields specified by the template.

20. The non-transitory computer readable medium of claim 18, wherein the output vector further indicates an arrangement of one or more sub-templates corresponding to at least a portion of the one or more fields specified by the template, and wherein the plurality of content item recommendations indicted by the output vector are selected based upon fields specified by the one or more sub-templates.
